(19) United States
(12) Patent Application Publication
(10) Pub. No.: US 2006/0002479 A1
(43) Pub. Date: Jan. 5, 2006

(54) Decoder for H.264/AVC video

(76) Inventor: Felix C. A. Fernandes, Plano, TX (US)

Correspondence Address: TEXAS INSTRUMENTS INCORPORATED, P O BOX 655474, M/S 3999, DALLAS, TX, 75265, US

(21) Appl. No.: 11/158,685

(22) Filed: Jun. 22, 2005

Related U.S. Application Data
(60) Provisional application No. 60/582,333, filed on Jun. 22, 2004.

(51) Int. Cl. H04B 1/66; H04N 11/02; H04N 11/04; H04N 7/12

(52) U.S. Cl. 375/240.25; 375/240.28

(57) ABSTRACT

A 16-bit fixed-point arithmetic version of the hypothetical reference decoder (HRD) of Annex C of the H.264 standard is derived by modification of the 32-bit floating point timestamps.

### CROSS-REFERENCE TO RELATED APPLICATIONS

This application claims priority from provisional application No. 60/582,333, filed Jun. 22, 2004.

### BACKGROUND OF THE INVENTION

The present invention relates to digital video signal processing, and more particularly to devices and methods for video coding.

There are multiple applications for digital video communication and storage, and multiple international standards have been and are continuing to be developed. Low bit rate communications, such as, video telephony and conferencing, led to the H.261 standard with bit rates as multiples of 64 kbps, and the MPEG-1 standard provides picture quality comparable to that of VHS videotape.

H.264/AVC is a recent video coding standard that makes use of several advanced video coding tools to provide better compression performance than existing video coding standards such as MPEG-2, MPEG4, and H.263. At the core of all of these standards is the hybrid video coding technique of block motion compensation and transform coding. Block motion compensation is used to remove temporal redundancy between successive images (frames), whereas transform coding is used to remove spatial redundancy within each frame. Traditional block motion compensation schemes basically assume that objects in a scene undergo a displacement in the x- and y-directions; thus each block of a frame can be predicted from a prior frame by estimating the displacement (motion estimation) from the corresponding block in the prior frame. This simple assumption works out in a satisfactory fashion in most cases in practice, and thus block motion compensation has become the most widely used technique for temporal redundancy removal in video coding standards. FIGS. 2a-2b illustrate H.264/AVC functions which include a deblocking filter within the motion compensation loop.

Block motion compensation methods typically decompose a picture into macroblocks where each macroblock contains four 8×8 luminance (Y) blocks plus two 8×8 chrominance (Cb and Cr or U and V) blocks, although other block sizes, such as 4×4, are also used in H.264/AVC. The transform of a block converts the pixel values of a block from the spatial domain into a frequency domain for quantization; this takes advantage of decorrelation and energy compaction of transforms such as the two-dimensional discrete cosine transform (DCT) or an integer transform approximating a DCT. For example, in MPEG and H.263, 8×8 blocks of DCT-coefficients are quantized, scanned into a one-dimensional sequence, and coded by using variable length coding (VLC). H.264/AVC uses an integer approximation to a 4×4 DCT.

The rate-control unit in FIG. 2a is responsible for generating the quantization step (qp) by adapting to a target transmission bit-rate and the output buffer-fullness; a larger quantization step implies more vanishing and/or smaller quantized transform coefficients which means fewer and/or shorter codewords and consequent smaller bit rates and files.

To enable an output-timing conformance video bitstream, an H.264/AVC encoder must guarantee that the Hypothetical Reference Decoder (HRD) of Annex C of the standard can decode the bitstream under an encoder-supplied delivery schedule with specified transmission bitrate, buffer size, and initial delay. Compliant decoders can then achieve output-timing conformance if they output frames with timestamps that differ negligibly from the HRD timestamps. The HRD specification uses 32-bit words and floating-point arithmetic to ensure a high-precision representation for the output-frame timestamps. However, for low-complexity decoder implementations, floating-point arithmetic is computationally expensive and it is therefore preferable to use 16-bit integer-arithmetic.

### SUMMARY OF THE INVENTION

The present invention provides a decoder for H.264/AVC bitstream with 16-bit integer-arithmetic output-frame timestamps by a truncation process of quantities to compute the decoded picture buffer output timestamps. These differ negligibly from the timestamps generated by the 32-bit floating point HRD of Annex C of H.264/AVC.

### BRIEF DESCRIPTION OF THE DRAWINGS

FIG. 1 shows buffers and a decoder.

FIGS. 2a-2b show H.264/AVC video coding functional blocks.

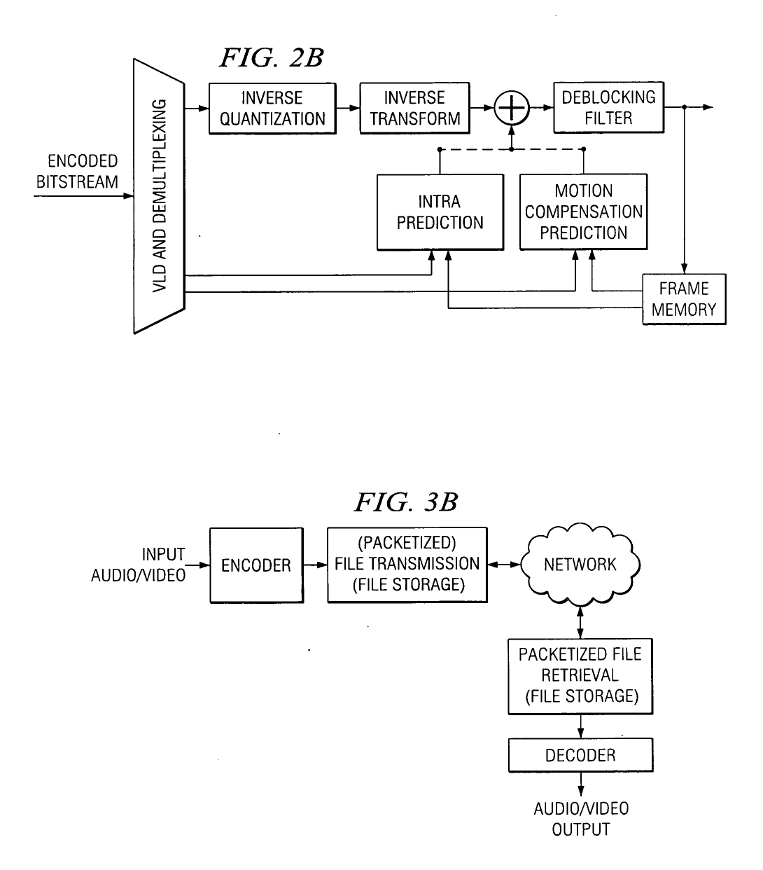

FIGS. 3a-3b illustrate applications.

### DESCRIPTION OF THE PREFERRED EMBODIMENTS

1. Overview

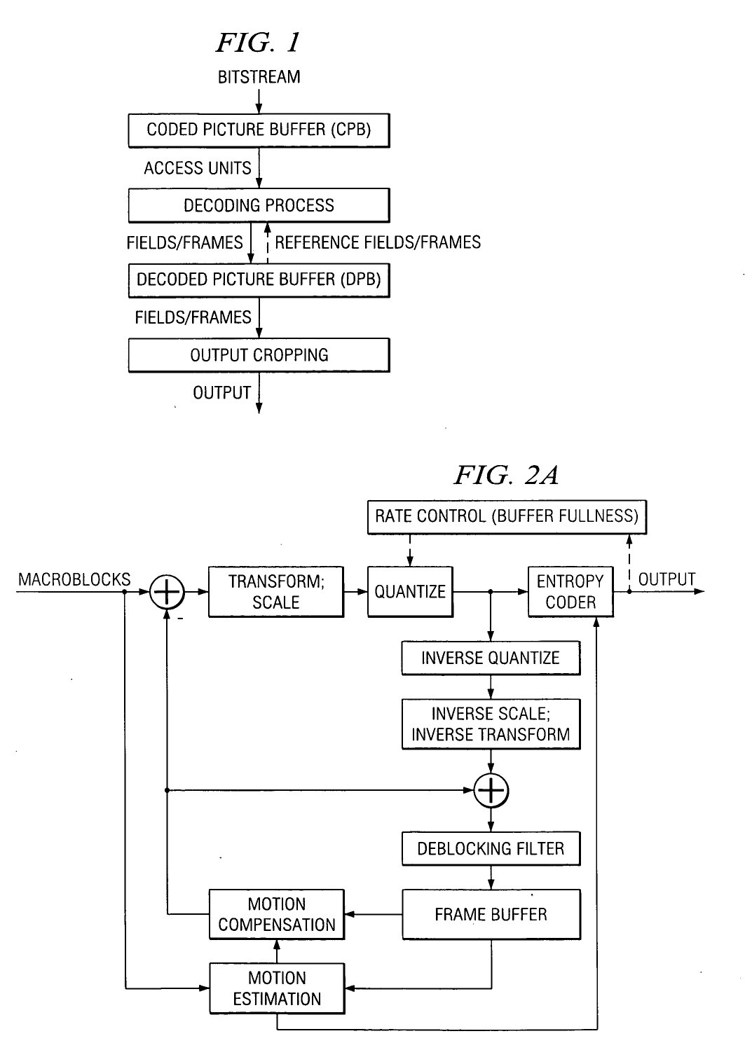

Preferred embodiment methods provide a decoder for H.264/AVC bitstream with 16-bit integer-arithmetic for decoded buffer output timestamps by a truncation process for the quantities time_scale, num_units_in_tick, initial_cpb_removal_delay, and 90000. The truncation process provides upper and lower bounds for two truncation parameters and finds solutions. FIG. 1 shows the buffer arrangement where the decoded picture buffer contains frame buffers; each frame buffer may contain a decoded frame, a decoded complementary field pair, or a single decoded field, each is marked as “used for reference” or is held for future output, e.g., reordered or delayed pictures.

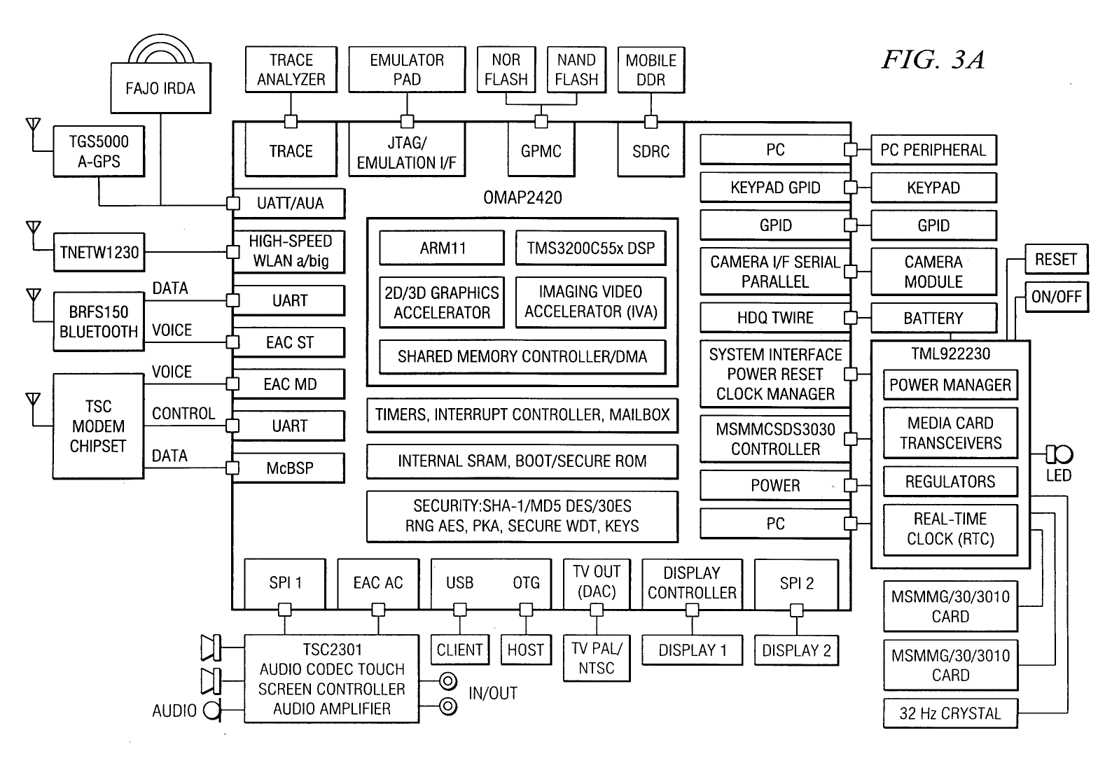

Preferred embodiment systems perform preferred embodiment methods with any of several types of hardware: digital signal processors (DSPs), general purpose programmable processors, application specific circuits, or systems on a chip (SoC) such as multicore processor arrays or combinations of a DSP and a RISC processor together with various specialized programmable accelerators (e.g., FIG. 3a). A stored program in an onboard or external (flash EEP) ROM or FRAM could implement the signal processing. Analog-to-digital converters and digital-to-analog converters can provide coupling to the analog world; modulators and demodulators (plus antennas for air interfaces) can provide coupling for transmission waveforms; and packetizers can provide formats for transmission over networks such as the Internet as illustrated in FIG. 3b.

2. First Preferred Embodiments

The first preferred embodiment methods provide a 16-bit, integer-arithmetic version of the H.264/AVC hypothetical reference decoder (HRD). Time intervals in the 32-bit, floating-point HRD are specified relative to two clocks, a fixed 90 KHz clock and another bitstream-dependent clock. The preferred embodiment methods find the minimum clock-precision reductions that enable the HRD output timestamps to be computed with 16-bit integer arithmetic.

In particular, there are several 32-bit quantities that may be truncated to obtain a 16-bit integer arithmetic version of HRD. However, accuracy will be lost if all these quantities are truncated without careful consideration. The following sections show that the cpb_removal_delay(n) and dpb_output_delay(n) quantities should not be truncated because they will usually not become very large. On the other hand, the clock-precisions and all related quantities should be truncated appropriately to retain precision. The first preferred embodiment method finds the minimum clock-precision reductions that enable the HRD output timestamps to be computed with 16-bit integer arithmetic. Indeed, the following shows how to determine the minimum truncation factors for the quantities initial_cpb_removal_delay, time_scale, num_units_in_tick, 90 Khz clock, initial_cpb_removal_delay_offset; and also shows that bitrate should not be truncated, but should be incorporated into a table-lookup division implementation.

The preferred embodiment methods can be summarized in two parts:
1) To minimize accuracy loss, determine what should and should not be truncated and what should be done using a table lookup for division,
2) Solve for the minimum number of bits to truncate.

First, briefly review HRD operation as described in Annex C of the H.264 standard. As shown in FIG. 1 an coded picture buffer (CPB) supplies pictures to the decoder which output decoded pictures to the decoded picture buffer (DPB); the decoder may use pictures stored in the DPB as references for motion compensation reconstructions. The HRD is initialized by a buffering-period message that specifies the quantities initial_cpb_removal_delay and initial_cpb_removal_delay offset, the delays required to fill up the decoder and encoder buffers. Subsequently, the nth encoded frame after the buffering-period message is accompanied by a picture-timing message containing cpb_removal_delay(n) and dpb_output_delay(n) which are used to calculate t_{o,dpb}(n), the output timestamp for Frame n. The HRD may be re-initialized at the transmission of any Instantaneous Decoder Refresh (IDR) frame. During re-initialization, n will be reset to 0. The low_delay_hrd_flag determines whether the HRD operates in a low-delay mode or not. First consider the preferred embodiment methods for the non-low-delay HRD operation in which low_delay_hrd_flag is not set. Then extend them to the low-delay HRD mode. Note that the non-low-delay HRD mode is used in the majority of applications for which decoding delay is not a critical factor.

3. Non-Low-Delay HRD Operation-Mode

According to Annex C, subclause C.1.2, in the non-low-delay mode, the output timestamp for Frame n is determined by the following equations:
tᵣ(0)=initial_{—}cpb_{—}removal_{—}delay/90000, (C-7)
tᵣ(n)=tᵣ(n_{b})+t_{c}*cpb_{—}removal_{—}delay(n), (C-8)
t_{o,dpb}(n)=tᵣ(n)+t_{c}*dpb_{—}output_{—}delay(n), (C-12)
where n_{b} specifies the frame associated with the most recent buffering-period message and the clock tick is
t_{c}=num_units_in_tick/time_scale. (C-1)
Thus a 90000 Hz clock is used for initial_cpb_removal_delay and a 1/t_{c} clock is used for cpb_removal_delay(n). To use integer-arithmetic to calculate t_{o,dpb}(n) and implement subclause C.2 for HRD-controlled Decoded-Picture Buffer (DPB) management, observe that there are three operations to account for: the division in equation (C-7) and the multiplication plus division in equations (C-8) and (C-12). These divisions can be avoided by scaling results up by 90000*time_scale (so t_{c} becomes 90000*num_units_in_tick) and using the following scheme. The equation (C-7) division is avoided by setting
tᵣ(0)=time_scale*initial_cpb_removal_delay. (1)
Similarly, the equation (C-8) division is avoided by setting (new t_{c})
tᵣ(n)=tᵣ(n_{b})+90000*num_{—}units_{—}in_{—}tick*cpb_{—}removal_{—}delay, (2)
and the equation (C-12) division is eliminated by computing
t_{o,dpb}(n)=tᵣ(n)+90000*num_{—}units_{—}in_{—}tick*dpb_{—}output_{—}delay. (3)
In addition to the above computations, we must also maintain our own internal system clock which we update by 1/16th second after every frame is decoded. Because this system clock is compared against t_{o,dpb}(n) to determine whether a frame is to be output (subclause C.2.3), the system clock must also be scaled up by 90000*time_scale. Therefore the system clock must be initialized to
sysClock=time_{—}scale*initial_{—}cpb_{—}removal delay, (4)
to simulate the initial_delay in filling up the Coded Picture Buffer (CPB) before the first frame is decoded.

Unfortunately, none of the above computations can be performed with 16-bit*16-bit multiplications because time_scale, initial_cpb_removal_delay, 90000, num_units_in_tick, cpb_removal_delay(n), and dpb_output_delay(n) may all be up to 32-bits long. Therefore, we must replace time_scale, 90000, initial_cpb_removal delay, and num_units_in_tick with lower-precision, truncated approximations. We do not replace cpb_removal_delay(n) and dpb_output_delay(n) with truncated approximations because dpb_output_delay(n) is typically small and for the initial frames, cpb_removal_delay(n) has small values although it will grow large for frames that are far from the preceding buffering-period message (large n). If cpb_removal_delay(n) is truncated, then several frames may end up with the same output timestamp and this may fill up the DPB. With untruncated cpb_removal_delay(n) and dpb_output_delay(n), these values may only grow until they are 16-bits long. Because buffering-period messages are expected to occur at fairly frequent intervals, this 16-bit restriction will not pose any problems.

To describe the truncation scheme, first recall that H.264 uses two different clock ticks (different from our internal sysClock) to specify time intervals. The first clock tick is 1/90000 second long and initial_cpb_remo-val_delay is specified by the number of ticks of this 90 KHz clock. The second clock tick is tc (=num_units_in_tick/time_scale) seconds long and cpb_removal_delay(n) and dpb_output_delay(n) are specified by the number of t_{c} ticks. Now truncate initial_cpb_removal_delay by scaleDn90 bits using
init_{—}delay_{—}truncd=initial_{—}cpb_{—}removal_{—}delay>>scaleDn90, (5)
and define
clk_{—}truncd=90000>>scaleDn90. (6)
where scaleDn90 will be determined below. Observe that the time interval specified by initial_cpb_removal_delay relative to the 90 KHz clock is approximately equal to the time interval specified by init_delay_truncd relative to a clock with frequency clk_truncd, because with floating-point divisions,

$$initial\_cpb \_removal \_delay / 90000 = \\ [ initial\_cpb \_removal \_delay / 2 \hat{} scaleDn90 ] / \\ [ 90000 / 2 \hat{} scaleDn90 ] , ≅ initial\_cpb \_removal \_delay ≫ scaleDn90 ) / ( 9000 ≫ scaleDn90 ) , = \\ init\_delay \_truncd / clk\_truncd .$$

Therefore the truncation in (5) reduces the accuracy of the time interval from initial_cpb_removal_delay/90000 seconds to init_delay_truncd/clk_truncd seconds.

Next, consider the truncation of time_scale and num_units_in_tick. Because we do not wish to truncate cpb_removal_delay or dpb_output_delay, these time intervals will still be specified in t_{c} units. Therefore, use the following truncation scheme which maintains t_{c} approximately constant:
tscale_{—}truncd=time_{—}scale>>scaleDnTc, (7)
num_{—}truncd=num_{—}units_{—}in_{—}tick>>scaleDnTc. (8)
where scaleDnTc will be determined below. Now observe that with floating-point divisions,

$$num\_truncd / tscale\_truncd = \\ ( num\_units \_in \_tick \text{≫} scaleDnTc ) / \\ ( time\_scale \text{>>} scaleDnTc ) , ≅ \\ ( num\_units \_in \_tick / 2 \hat{} scaleDnTc ) / \\ ( time\_scale / 2 \hat{} scaleDnTc ) = \\ num\_units \_in \_tick / time\_scale = {t}_{c}$$

Therefore, the truncation in equation (5) reduces the accuracy of t_{c} from num_units_in_tick/time_scale seconds to num_truncd/tscale_truncd seconds.

Next, use the approximations in equations (5)-(8) to compute equations (1)-(4) with 16-bit integer arithmetic. Assuming that all computed values are now scaled up by clk_truncd*tscale_truncd, we can rewrite equations (1)-(4) as
tᵣ(0)=tscale_{—}truncd*init_{—}delay_{—}truncd, (9)
tᵣ(n)=tᵣ(n_{b})+clk_{—}truncd*num_{—}truncd*cpb_{—}removal_{—}delay, (10)
t_{o,dpb}(n)=tᵣ(n)+clk_{—}truncd*num_{—}truncd*dpb_{—}output_{—}delay, (11)
sysClock=tscale_{—}truncd*init_{—}delay_{—}truncd. (12)
Equations (9)-(12) allow us to determine scaleDn90 and scaleDnTc as follows. The 16-bit restrictions on the lengths of tscale_truncd, num_truncd, init_delay_truncd, and clk_truncd impose the following constraints respectively, where |.| denotes the bitlength of its operand,
scaleDnTc>=|time_{—}scale|−16, (13)
scaleDnTc>=|num_{—}units_{—}in_{—}tick|−16. (14)
scaleDn90>=|initial_{—}cpb_{—}removal_{—}delay|−16, (15)
scaleDn90>=1, (16)
Additionally, from equation (10), because we assume |cpb_removal_delay|<16, we must have |clk_truncd|+|num_truncd|<=16, for 16-bit*16-bit multiplication. This implies that
scaleDn90+scaleDnTc>=|num_{—}units_{—}in_{—}tick|+1. (17)
Combining inequalities. (13), (14) gives us
scaleDnTc>=max{|time_{—}scale|, |num_{—}units_{—}in_{—}tick|}−16, (18)
and combining inequalities (15), (16) yields
scaleDn90>=max{|initial_{—}cpb_{—}removal_{—}delay|−16, 1}. (19)
Inequalities (17)-(19) establish lower bounds on scaleDn90 and scaleDnTc. If any of these lower bounds is negative, then it should be replaced with 0 because scaleDnTc and scaleDnTc must be non-negative. We evaluate upper bounds for scaleDnTc and scaleDn90 by applying the constraint that the lengths of tscale_truncd, num_truncd, init_delay_truncd, and clk_truncd must be greater than 0. This gives us the following inequalities:
scaleDnTc<=|time_{—}scale|−1, (20)
scaleDnTc<=|num_{—}units_{—}in_tick|−1, (21)
scaleDn90<=|initial_{—}cpb_{—}removal_{—}delay|−1, (22)
scaleDn90<=16. (23)
On combining inequalities (20), (21) we obtain
scaleDnTc<=min{|time_{—}scale|, |num_{—}units_{—}in_{—}tick|}−1, (24)
and from inequalities (22), (23), we get
scaleDn90<=min{|initial_{—}cpb_removal_{—}delay|−1, 16}. (25)
Next, we must assign values to scaleDnTc and scaleDn90 in accordance with the lower bounds in inequalities (17)-(19) and the upper bounds in inequalities (24) and (25). For maximum accuracy, we want scaleDnTc and scaleDn90 to be as small as possible. Therefore, we use inequalities (18) and (19) to determine that
scaleDnTc=max{|time_{—}scale|, |num_{—}units_{—}in_{—}tick|}−16, (26)
scaleDn90=max{|initial_{—}cpb_{—}removal_{—}delay|−16, 1}. (27)
Then we determine whether inequality (17) is satisfied. If not, we must increase scaleDn90 and/or scaleDnTc to satisfy the inequality. We shall increase both scaleDn90 and scaleDnTc equally to comply with inequality (17). We accomplish this by first defining delta as
delta=|num_{—}units_{—}in_{—}tick|+1−(scaleDn90+scaleDnTc), (28)
and then performing
scaleDn90+=(delta>>1), if delta is even,
scaleDn90+=(delta>>1)+1, if delta is odd, (29)
scaleDnTc+=(delta>>1). (30)
Equations (29) and (30) may easily be modified to allow for unequal increments to scaleDn90 and scaleDnTc.

Finally, we must check whether the upper bounds in inequalities (24) and (25) are met. If not, then we need to vary the assignments to scaleDn90 and scaleDnTc in equations (29) and (30) until the upper bounds in inequalities (24) and (25) are satisfied. The following pseudocode implements this assignment procedure:

```
    Initialize scaleDn90, scaleDnTc using equations. (29), (30)
    halfDelta = delta >> 1
    for (ii = −halfDelta; ii <= halfDelta; ii++)
      scaleDn90 += ii
      scaleDnTc −= ii
      if Inequalities (18), (19), (24), (25) are satisfied
          printf(“scaleDn90, scaleDnTc satisfy upper and lower
bounds”)
          exit
    printf(“No solution exists for scaleDn90, scaleDnTc.”)
```

This pseudocode implements the exhaustive-search solution to the set of linear inequalities (17), (18), (19), (24), (25). Note that for most bitstreams this exhaustive search does not have to be performed because inequalities (24) and (25) are usually satisfied by the initial assignments to scaleDn90 and scaleDnTc in equations (29), (30).
4. Example

Let us now examine the precision-loss incurred by the preferred embodiment methods of conversion to 16-bit integer arithmetic timestamps while decoding the CVSE2_SONY_A H.264 bitstream. In this bitstream there is only one buffering-period message and the relevant syntax elements are decoded with the following values: initial_cpb_removal_delay=45000, time_scale=60000, num_units_in_tick=1001, low_delay_hrd_flag=0. For all frames, both cpb_removal_delay(n) and dpb_output_delay(n) are less than 661. From the preceding values, the initial decoding delay is calculated to be 45000/90000=0.5 seconds and t_{c} is computed as 1001/60000=0.01668 seconds. Thus the lower bound inequalities constraining scaleDn90 and scaleDnTc are:
scaleDnTc>=|time_{—}scale|−16=0 (13)
scaleDnTc>=|num_{—}units_{—}in_{—}tick|−16=−6 (14)
scaleDn90>=|initial_{—}cpb_{—}removal_{—}delay|−16=0 (15)
scaleDn90>=1 (16)
scaleDn90+scaleDnTc>=|num_{—}units_{—}in_{—}tick|+1=11 (17)
And the upper bound inequalities are:
scaleDnTc<=|time_{—}scale|−1=15 (20)
scaleDnTc<=|num_{—}units_{—}in_{—}tick|−1=9 (21)
scaleDn90<=|initial_{—}cpb_{—}removal_{—}delay|−1=15 (22)
scaleDn90<=16 (23)
Then use equations (26)-(30) to find scaleDn90=6 and scaleDnTc=5 which satisfy the upper and lower bounds. These values lead to the following approximations to the preceding syntax elements: init_delay_truncd=703, tscale_truncd=1875, num_truncd=31, clk_truncd=1406. With these approximations, the initial decoding delay is 703/1406=0.5 seconds and we compute t_{c}=31/1875=0.01653 seconds. Therefore, the approximation errors for the initial decoding delay and t_{c} are 0 seconds and 0.153 milliseconds respectively. Because t_{c} is used twice in the computation of the output timestamp t_{o,dpb}(n), the maximum error in t_{o,dpb}(n) is 0.306 milliseconds. Using the floating-point HRD in Annex C, output timestamps are spaced 33.3 milliseconds apart. Therefore the preferred embodiment method 16-bit integer-arithmetic HRD introduces a maximum output timestamp error of 0.919%.

Recall that the quantities had been scaled up by 90000*time_scale in equations (1)-(3) to avoid divisions; and the actual computations with the truncated quantities are in equations (9)-(12).

5. Low-Delay HRD Operation-Mode

According to Annex C, SubClauses C.1.1 and C.1.2, in the low-delay mode, the output timestamp for Frame n is determined by the following equations, where b(n) is the size in bits of the encoded nth frame and bitrate is the specified transmission bitrate:

| tᵣ(0) = initial_cpb_removal_delay / 90000, | (C-7) |
|---|---|
| t_{r,n}(n) = tᵣ(n_{b}) + t_{c} * cpb_removal_delay(n), | (C-8) |
| If n == 0 | |
| tₐᵢ(0) = 0 | |
| Else | |
| If constant-bit-rate | |
| tₐᵢ(n) = t_{af}(n−1) | (C-2) |
| Else | |
| If first frame of buffering period | |
| t_{ai,earliest}(n) = t_{r,n}(n−1) − | |
| initial_cpb_removal_delay/90000 (C-5) | |
| Else | |
| t_{ai,earliest}(n)= t_{r,n}(n−1) − (initial_cpb_removal_delay + | |
| initial_cpb_removal_delay_offset/90000) | (C-4) |
| tₐᵢ(n) = max{ t_{af}(n−1), t_{ai,earliest}(n)} | (C-3) |
| t_{af}(n) = tₐᵢ(n) + b(n)/bitrate | (C-6) |
| tᵣ(n) = t_{r,n}(n) + t_{c} * Ceil[(t_{af}(n) − t_{r,n}(n))/t_{c}] | (C-11) |
| t_{o,dpb}(n) = tᵣ(n) + t_{c} * dpb_output_delay(n), | (C-12) |

Similar to the non-low-delay mode, we may use the following 16-bit integer arithmetic HRD to compute the output timestamp t_{o,dpb}(n) with the following scheme. First, we define the truncated quantity:
init_{—}offset_{—}truncd=initial_{—}cpb_{—}removal_{—}delay_{—}offset>>scaleDn90, (31)

and then we use a table lookup to obtain B16, a 16-bit approximation to b(n)/bitrate in millisecond units. To compute the output timestamp t_{o,dpb}(n) scaled up by clk_truncd*tscale_truncd, we now use the following sequence of equations:

| | |
|---|---|
| tᵣ(0) = tscale_truncd * init_delay_truncd, | (32) |
| tᵣ(n) = tᵣ(n_{b}) + clk_truncd * num_truncd * | (33) |
| cpb_removal_delay(n), | |

| | |
|---|---|
| If n == 0 | |
| tₐᵢ(0) = 0 | (34) |
| Else | |
| If constant-bit-rate | |
| tₐᵢ(n) = t_{af}(n−1) | (35) |
| Else | |
| If first frame of buffering period | |
| t_{ai,earliest}(n) = t_{r,n}(n−1) − | |
| tscale_truncd * init_delay_truncd | (36) |
| Else | |
| t_{ai,earliest}(n)= t_{r,n}(n−1) − | |
| tscale_truncd * | |
| (init_delay_truncd+init_offset_truncd) | (36) |
| tₐᵢ(n) = max{ t_{af}(n−1), t_{ai,earliest}(n)} | (37) |
| nBits = \|clk_truncd\| + \|tscale_truncd\| | (38) |
| If (nBits <= 16) | |
| t_{af}(n) = tₐᵢ(n) + (B16*( clk_truncd * tscale_truncd))>>10 | (39) |
| Else | |

t_{af}(n) = tₐᵢ(n) + (B16 * ((clk_truncd * tscale_truncd)>>(nBits−16)))>>

| | |
|---|---|
| (26−nBits)) | (40) |
| tᵣ(n) = t_{af}(n) | (41) |

t_{o,dpb}(n) = tᵣ(n) + clk_truncd * num_truncd * dpb_output_delay(n) (42)

| | |
|---|---|
| sysClock = tscale_truncd * init_delay_truncd | (43) |

Because B16 is in milliseconds, we must right shift it by 10 bits to convert it to seconds. Equations (39) and (40) perform this shift while accounting for the scaling by clk_truncd*tscale_truncd.

What is claimed is:

1. A method of decoding a H.264/AVC-type bitstream, comprising:
(a) truncating a constant clock rate, an initial coded picture buffer removal delay, a time scale, and a number of units in a clock tick; and
(b) computing a decoded picture buffer output timestamp using the results of step (a);
(c) wherein said truncating of a constant clock rate and said truncating of an initial coded picture buffer removal delay are both by a first bit shift, and wherein said truncating of a time scale and said truncating a number of units in a clock tick are both by a second bit shift.

2. The method of claim 1, further comprising:
(a) truncating an initial coded picture buffer removal delay offset by said first bit shift;
(b) approximating the quotient of the bit size of a frame divided by a specified bitrate; and
(c) including the results of steps (a) and (b) in said computing of step (b) of claim 1.

3. The method of claim 1, wherein:
(a) said first bit shift and said second bit shift are determined by inequalities with the number of bits in each of said a constant clock rate, an initial coded picture buffer removal delay, a time scale, and a number of units in a clock tick.
